(19) United States
(12) Patent Application Publication
(10) Pub. No.: US 2008/0052508 A1
(43) Pub. Date: Feb. 28, 2008

(54) Network security status indicators

(76) Inventors: Allen J. Huotari, Garden Grove, CA (US); Kendra S. Harrington, Irvine, CA (US); Matthew Mcrae, Laguna Beach, CA (US); Sanjay Poojary, Tustin, CA (US)

Correspondence Address: Don C. Lawrence;MacPHERSON KWOK CHEN & HEID LLP, Suite 226, 1762 Technology Drive, San Jose, CA, 95110, US

(21) Appl. No.: 11/510,409

(22) Filed: Aug. 25, 2006

(51) Int. Cl. H04L 9/00

(52) U.S. Cl. 713/153

(57) ABSTRACT

In one embodiment, a method includes an apparatus includes a programmable microprocessor that determines the current security status of a network, generates a signal corresponding to the status, and applies the signal to an indicating device to produce an indication of the security status of the network that is sensible to a user. The indicating device can include an electric light source, such as an LED, or a electro-acoustic transducer, such as a loudspeaker, or both, that produces different colors of light or different sounds or that flashes or sounds intermittently to indicate the current security status of the network, to warn of an unexpected change in the level of security, or to indicate the functionality of other network security measures, such as a firewall or VPN.

### BACKGROUND

This invention pertains to networks in general, and in particular, to apparatus and methods for providing users of a network with a sensory indication of the current security status of the network.

Security of wireless and wired networks is an ever-growing problem. Home and small business networks in particular are typically either unsecured or only minimally secured, i.e., via Wired Equivalent Privacy (WEP) or Network Address Translation (NAT) security measures. Most end users are either simply unaware of the risks involved in running an unsecured network, or are not comfortable with setting up or configuring system security.

Additionally, once a network has been secured, any pre-shared security element, i.e., a “passphrase” (in Wi-Fi Protected Access (WPA)), or an RC4 encryption “key” (in WEP), or a network “password” (HomePlug and MoCA), or an authentication credential, or other media independent security parameters should be changed regularly to maintain the level of security provided by use of the security element and to prevent key recovery attacks, such as so-called “dictionary attacks.”

Furthermore, current home and small business networking devices may have a range of security capabilities. For example, in a wireless network, while the network Access Point (AP) may be capable of both WPA and WEP security, certain wireless clients (i.e., a wireless IP camera or network printer) may capable of effecting only WEP security. Users should preferably configure their network for the highest possible security option that all devices are capable of, and should be warned if the highest possible security option is not the optimal security (as in the above example, the AP must be set at WEP (a less secure setting) to accommodate the wireless IP camera). Additionally, some currently available APs will actually automatically decrease their configured security settings to accommodate a wireless client with lower security capabilities without informing the user that the security level of the network has been decreased.

Finally, other aspects of security on a given network are important and should be indicated to the end user or owner. For example, it is important that a firewall be set up and configured to guard the network from outside attacks. A Virtual Private Network (VPN) may optionally be used to further secure a network connection. However, it is often the case that a technically unsophisticated user is unable to determine whether these software security mechanisms are operative and/or configured properly.

### BRIEF DESCRIPTION OF THE DRAWINGS

FIG. 1 illustrates an example home or small business local area network having an Access Point (AP) including an example network security status indicator;

FIG. 2 illustrates another example network having a gateway incorporating an example security status indicator;

FIG. 3 illustrates an example network having standalone components and incorporating an example security status indicator;

FIG. 4 illustrates an example network AP;

FIG. 5 illustrates an example method for determining the current security status of a network and for indicating that status to a user of the network;

FIG. 6 illustrates an example method for detecting and indicating to a user of the network the need to change an encryption element of the network;

FIG. 7 illustrates another example method for detecting and indicating to a user of the network the need to change an encryption element of the network; and,

FIG. 8 illustrates another example method for detecting and indicating to a user of the network the need to change an encryption element of the network.

### DESCRIPTION OF EXAMPLE EMBODIMENTS

In accordance with the particular example embodiments thereof described herein, a method and apparatus are provided by which a user of a network is continuously informed of the current security status of the network, as well as the functioning of other security features thereof.

In one particular example embodiment, a multicolor light emitting diode (LED) or liquid crystal display (LCD) is implemented on an Access Point (AP) or other Station (STA) of a network to indicate the current security status of the network. The LED can be programmed to light up, i.e., red when no security is enabled, amber when the network is minimally secured (i.e., by WEP), and green when the network is optimally secured, (i.e., by WPA or WPA2).

In addition, the LED can be programmed to blink, or flash, in red, amber or green (as appropriate) after a predetermined amount of network operating time has elapsed to indicate that the network security element, such as a key or a passphrase, needs to be changed to maintain good security. The elapsed time span between indications of the need for a key change can be fixed (e.g., one week), user modifiable (i.e., selected by the user), or the interval between the need for key change can be made dependant upon the traffic history of the network (i.e., an indication of the need for a key change every 100 MB of wireless traffic transported or an indication of the need to change a security element (i.e., after 50 unique STAs have been connected).

Alternatively, a single color LED can be used to indicate similar status messages, i.e., off when unsecured, flashing when minimally secured or when a network security element needs to be changed, and lit continuously when the network is optimally secured.

Alternatively, multiple LEDs operating in either single or multicolor modes can be used in combination to indicate the various security status messages (i.e., an LED1 “on” when wireless security is enabled, and an LED2 “on” when WPA is enabled or “off” when WEP is enabled).

Additionally, one or more LEDs can be used to convey the status of other network security parameters (i.e., home router/gateway features). For example, the LED can indicate red when the firewall is disabled, amber when it is enabled but certain ports are open, or when exceptions have been made to the security configuration, and green when the firewall is configured to its most secure state. The LED can also be used to convey other software security measures, such as VPN or Parental Control status, if a network device has been power-cycled, a network device has been reset to factory defaults, and if any parameters have been changed without an authorized user's acknowledgement.

As either an alternative or a complement to LEDs, a small electro-acoustic transducer, i.e., a piezoelectric loudspeaker, can be used to audibly notify the user for a brief period of time that the security level of the network has been changed, i.e., decreased, increased or turned off. The type of sound produced by the speaker can be programmed to change, depending on the type of security change that has occurred. It is also possible to notify the user by means of other stimuli that act on the other senses, i.e., touch, taste and/or smell, but regardless of the particular sensory notification mechanisms implemented, they preferably should produce a network security status message that is immediate, both temporally and proximally, reliable, unambiguous and expressed in such as a way as to give actual notice to even a relatively unsophisticated user of the network.

In yet another particular embodiment, and in addition or as an alternative to the visual or audible indicators, network security status messages, including warnings of security level changes, can also be displayed with a Graphical User Interface (GUI) configuration utility, or via a configuration “wizard” or other utility used to manage the network.

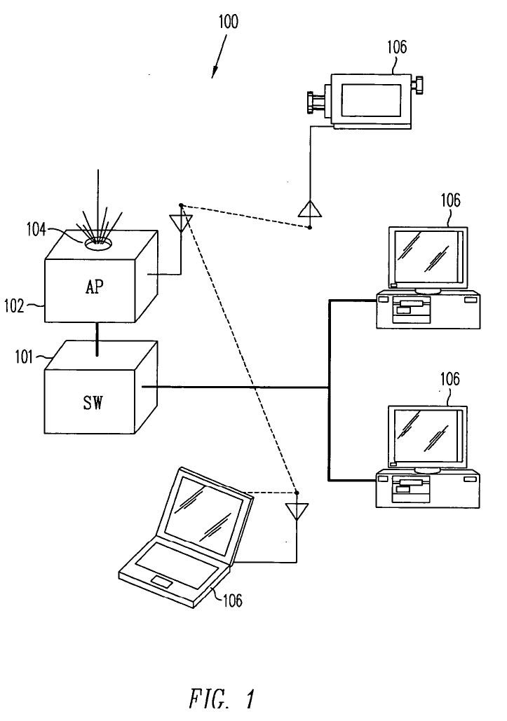

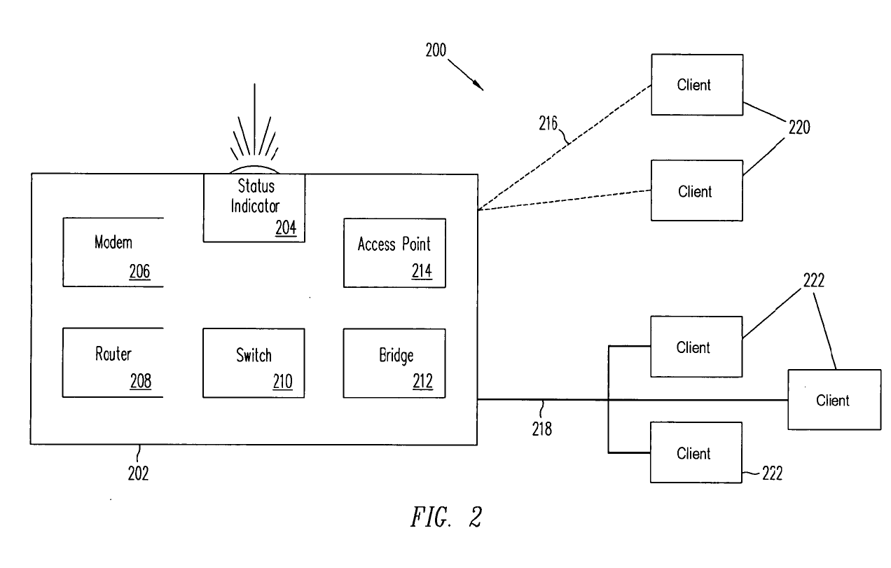

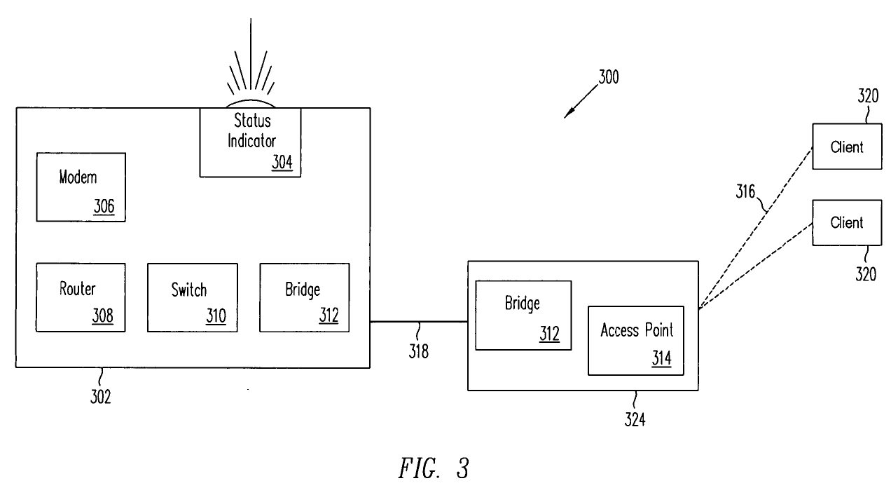

FIG. 1 is a schematic perspective view of an example home or small business local area network (LAN) 100 having a conventional network switch (SW) 101 and a wireless Access Point (AP) 102 incorporating a particular embodiment of a network security status indicator 104 in accordance with the present invention. The network illustrated in FIG. 1 includes both wired and wireless connections. However, it should be understood that the apparatus and methods of the present invention are also applicable to networks that are either “homogeneous,” i.e., all wired or all wireless and using a single physical medium, or “heterogeneous,” i.e., utilizing more than one physical medium, which can include multiple wired media, i.e., powerline, phoneline, coaxial, CATn, or multiple wireless media, i.e., 802.11, Bluetooth, UWB, and ZWave. Accordingly, the example AP 102 illustrated can also represent any one of a number of different types of “bridges” that function to connect one physical network to another, such as those described below and illustrated in FIGS. 2 and 3.

FIGS. 2 and 3 are functional block diagrams respectively illustrating two of many possible alternative particular embodiments of networks 200 and 300 to which the present invention has advantageous application. Each of these two example networks includes a network gateway 202, comprising any combination of a modem 206, a router 208, a switch 210, a bridge 212, and a wireless access point (AP) 214, which provides connectivity via wireless and wired segments 216 and 218 of the network for a plurality of wireless and wired networked devices 220 and 222, respectively. As illustrated in the figures, the networking functionality can be integrated into a single gateway device, or alternatively, as illustrated in FIG. 3, provided as a plurality of distributed, stand-alone devices (effectively, a “virtual gateway”).

The modem 206 provides connectivity for the network 200 to a broadband access network (not illustrated), which in turn, provides connection to the Internet (not illustrated). The router 208 forwards traffic to/from the network 200 and the broadband access network. The router function is necessary to enable the firewall and NAT technologies referred to herein.

The AP 214 provides connectivity for the wireless segment 216 of the network, which can be implemented in 802.11, Bluetooth or other wireless technologies that connect via the access point 214, and can be either heterogeneous or homogeneous.

The switch 210 provides connectivity for the wired segment 218 of the network, which can include Ethernet 10/100/1000 BaseT (connected via the switch 210), and other well known wired technologies, such as MoCA, HPNA, or HomePlug (connected via the bridge 212). The wired segment 218 of the network may also be either heterogeneous or heterogeneous.

The bridge 212 provides connectivity between any two or more heterogeneous technologies, i.e., MoCA 218, HPNA 218, HomePlug 218, Ethernet 218, IEEE 802.11 216, Bluetooth 216, and the like.

The networked devices, such as wireless clients 220 or wired clients 222, can comprise a computing device, such as a desktop or laptop computer, or other type of networkable apparatus, i.e., a camera, printer, a TV set top box (STB), or any other type of IP-based device.

As discussed above, the network gateway 202, 302 functionality can be separated into or augmented by stand-alone devices, such as the separate bridge/AP device 324 illustrated in FIG. 3. For example, in the networks of 100 and 200 of FIGS. 1 and 2, the wireless functionality is integrated into the AP 102 and the gateway 202, respectively, whereas, in the network 300 of FIG. 3, the wireless functionality 314 is provided in an external device 324 that is separate from the network gateway 302.

In the network 300 of FIG. 3, the standalone external bridge/AP device 324 is connected to the network gateway 302 via a wired technology 318, such as MoCA, HPNA, or HomePlug, via a bridge 312 at both ends of the connection. As in the particular embodiments of FIGS. 1 and 2, the AP 314 continues to provide network connectivity to the wireless clients 320 via a wireless medium 316, whereas, the wired medium 318, i.e., Ethernet (10/100/1000 BaseT), connects to a switch 310 in the gateway 302.

As those of skill in the art will appreciate, network security status can be inclusive of the entire network 100, 200, 300, or can be explicitly applied to a particular network segment or network medium, as exemplified by the wired network media 218 and 318 and the wireless network media 216 and 316 of FIGS. 2 and 3. For example, in the example network 300 of FIG. 3, the external bridge/AP device 324 can detect, analyze, and separately indicate the respective security status of both the wired segment 318 and the wireless segment 316 of the network, and these respective security statuses may be distinct and separate. As a further example, the network gateway devices 202 and 302 of either FIG. 2 or 3 can provide security status for the router 208 or 308 and the modem 206 or 306 functionality. An extension of this method is to arrange for the external bridge device 324 of FIG. 3 to notify the network gateway 302 of the status of all network security features, and for the gateway 302 to then indicate the security status of the entire network 300, in addition to each of the wired and wireless segments 316 and 318 thereof.

For brevity of description, an example of such a “security notification” in the heterogeneous, i.e., wireless and wired network 100 of FIG. 1 is described below, although it should be understood that the techniques are equally applicable to the other particular embodiments of networks, such as the example networks 200 and 300 of FIGS. 2 and 3, respectively.

With reference to FIG. 1, the network 100 comprises a heterogeneous “infrastructure” network, in that communications between nodes 106, i.e., laptop and desktop personal computers (PCs), are all coordinated through the AP 102. In another example (not illustrated), communication directly between nodes without traversing an AP is permissible. The network may implement any suitable wired and/or wireless networking protocol, and the protocol may incorporate one or more known network security protocols, such as NAT, WEP, WPA and WPA2, that enable the nodes of the network to communicate with each other with various levels of security, and also enable additional nodes, such as an IP camera (not illustrated), a Set Top Box (not illustrated), a Dual-Mode Phone (not illustrated), or wireless printer (not illustrated), to join, or associate with, the network. In addition to the foregoing network security protocols, the network may also incorporate additional security features, such as a firewall or Virtual Private Network (VPN) that are implemented in either software and/or hardware.

FIG. 4 is a functional block diagram of the example network AP 402 of FIG. 1, illustrating the provision therein of an particular example embodiment of the simple, yet reliable network security status indicator mechanism 404 of the present invention. The AP comprises a wireless transceiver 412 (i.e., a transmitter and receiver comprising amplifiers, filters, and the like, commonly referred to collectively as “the radio”). In the particular AP embodiment of FIG. 4, the AP antenna 414 of the radio is considered to be part of the wireless transceiver component.

The AP 402 further comprises a wireless Baseband/Medium Access Control (MAC) controller 416 that provides conversion from analog to digital (A/D), digital to analog (D/A), and wireless Medium Access Control (MAC) for the AP. The wireless Baseband/MAC essentially controls how and when the AP receives and transmits data over the network wirelessly.

The AP 402 further includes a controller 418 (typically comprising a programmable microprocessor) that forwards information between the wired and wireless portions of the network 100, and an AP memory subsystem 420 that can include both volatile and non-volatile system memory. The controller is also responsible for providing a Graphical User Interface (GUI), typically via an embedded “web server” application. It is via the GUI that an end user can initialize and configure the AP via a web browser, i.e., Microsoft Internet Explorer, running on, i.e., a personal computing device, including the configuration of the security features of the network. In the particular example embodiment illustrated in FIG. 4, the memory subsystem 420 is shown as incorporated within the controller, but in other possible embodiments, it may be implemented separately from the controller. The controller and memory subsystem are also responsible for maintaining the configuration and status of the AP, including network security. In accordance with the present invention, the controller maintains the configuration of the security functionality and status, or security level, of the network and displays that status to the user of the network continuously during operation of the network in the manner described below.

The AP 402 further includes a power supply 422 for the conversion and supply of electrical power to the AP, a reset mechanism for manually resetting the configuration of the AP, and a wired transceiver/MAC 424, which includes a transmitter and a receiver comprising a transformer, A/D and D/A conversion functions, filters and the like, and a conventional MAC controller that controls how and when the AP receives and transmits over the network via its wired interface 426. In the particular embodiment of FIG. 4, the physical connector 428 (i.e., an RJ-45 for Ethernet) is shown implemented directly in the transceiver portion of the wired transceiver/MAC component.

The status indicator 404 of the example AP 402 illustrated in FIG. 4 preferably comprises two sets of indicators: 1) a set of conventional network operational status indicators, and 2) a set of network security status indicators. The former usually comprise light sources, typically LEDs, driven by a general purpose input-and-output (I/O) subsystem of the controller 118, that display standard network operational status of the AP, i.e., Radio on/off, Wireless LAN activity (flashing), Wired LAN activity (flashing), Wired LAN connected (on/off), and Power (on/off).

The second set of status indicators 404 are directed to indicating the security level of the network, and preferably comprise an electric light source, such as one or more LEDs, an electro-acoustic transducer, such as a piezoelectric loudspeaker, or both types of transducers, that are also driven by an I/O subsystem of the controller 418. In accordance with the present invention, the second set of the indicating devices are implemented in the AP 402 for the specific purpose of conveying not only the current security status of the network to a user in a visible and/or audible manner, but also other security parameters of the network, such as the “age” of the security configuration.

In only one of many possible particular example embodiments, the network security status indicating device 404 can comprise a simple, single, tri-color LED, and the current network security configuration can be indicated to the user as follows: Off=no security enabled; Red (solid on)=WEP (low security); Amber (solid on)=WPA (medium security); Green (solid on)=WPA2 (highest security); (flashing)=security configuration is “stale” (i.e., encryption element is too old, or too much traffic has been transmitted/received over the network using the same key). As an alternative to the flashing LED, or to invite the user's immediate attention to it, the electro-acoustic device can be caused to emit an audible, i.e., a “beeping” or a “ringing” alarm tone for a selected period of time upon a change occurring in the security status.

Alternatively, the security status indicating device 404 can comprise a plurality of LEDs that are lighted in various combinations to indicate a variety of security status messages. For example, a first LED can be illuminated when wireless security is enabled, and a second LED can be illuminated when WPA is enabled or turned off when WEP is enabled. Additionally, the security status indicating device can be used to convey the status of other network security parameters. For example, a dedicated multicolor LED can indicate red when a network firewall is disabled, amber when the firewall is enabled but certain ports are open or exceptions have been made to the security configuration, and green when the firewall is configured to its most secure state. The security status indicating device 404 can also be used to convey the operation of other software security measures, such as the status of a VPN, Parental Control measures, MoCA, Homeplug, and other security features.

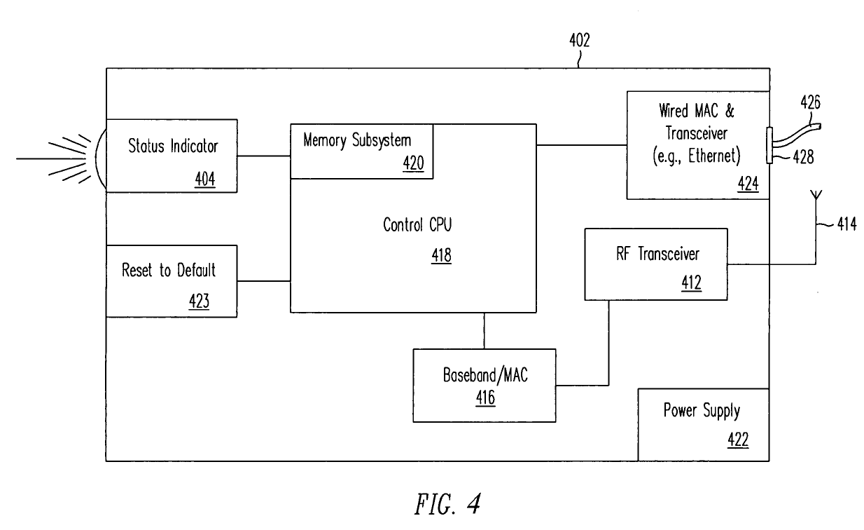

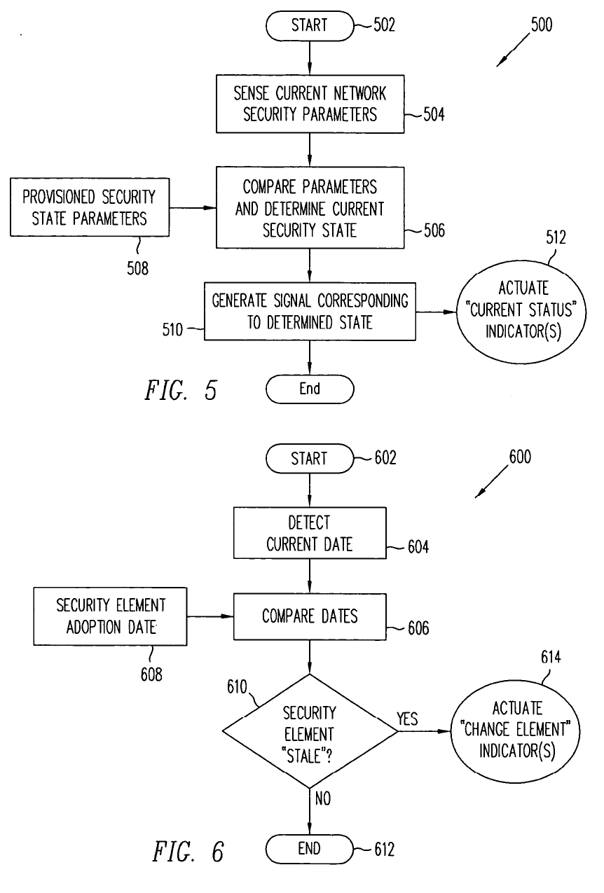

A particular example embodiment of a method 500 by which the example network security status indicator 404 of the AP 402 of the network 100 detects the current security status of the network and indicates that status to a user of the network in accordance with the present invention is illustrated in the flow chart of FIG. 5. Referring to FIG. 5, the method 500 begins in step 502 with a routine programmed in the AP controller 418, causing it in step 504 to initiate a sensing, or detection, of a selected group of network operational parameters associated with the current security state, or status, of the network, i.e., security enabled, age of a security element such as a key or passphrase, number of clients logged on, firewall enabled, and the like. In step 506, the controller then compares the parameters sensed from the network with a plurality of groups of corresponding parameters, each of which groups is uniquely associated with a corresponding one of a number of possible security states of the network, i.e., none, WEP, WPA, WPA2, firewall enabled, and the like, that were stored in the memory subsystem 420 of the controller at the time the security features of the network were initially set up, or provisioned, by the user, or a network administrator, in step 508, and based on this comparison, makes an assessment or determination of the actual current operational security status of the network. Based on the determination made, in step 510, the controller then generates a signal that corresponds uniquely to the particular security status determination and applies it, via the I/O subsystem of the controller, to the security status indicator 204 of the network in step 512, causing the indicator to emit a signal of the many possible types discussed above that is sensible by the user and uniquely indicative of the actual current security status of the network.

FIGS. 6-8 are flow charts illustrating other example methods by which the network security status indicating apparatus 404 can be used to indicate to a user of the network the need to change a network security encryption element, such as a passphrase or an encryption key, that has become “stale” due to age or overuse, or possibly compromised by virtue having been used by a large number of users on the network. For example, in the example method 700 illustrated in FIG. 6, a routine programmed in the controller 418 of the AP 402, and implementing an example method based on the age of the existing network encryption element, is initiated at step 602.

The routine may be initiated manually by the user, or preferably, automatically by the controller, either continuously or at selected intervals during the operation of the network. At step 604, the controller 418 retrieves the current date, either from an internal system clock/calendar (not illustrated) or from an external source, and at step 606, compares the current date with the date on which the current encryption element was adopted, which was previously stored in the memory subsystem 420 of the AP 402 at step 608 at the time of its adoption. The two points in time are mathematically compared, and a determination is made at step 610 of whether the element is “stale,” i.e., whether the length of time that the key has been in use exceeds the stored selected value, i.e., a week or a month, which value can be either pre-programmed in the system or selected by the user and stored in the AP controller memory subsystem at the time the security provisions of the network are initially set up or reconfigured. If the encryption key is still “fresh,” the routine terminates at step 612, and if the key is “stale,” the controller generates a signal that actuates the security status indicator 404 at step 614 to indicate to the user, i.e., by “flashing” an LED, i.e., switching it on and off rapidly, that the network needs to be provisioned with a new encryption element.

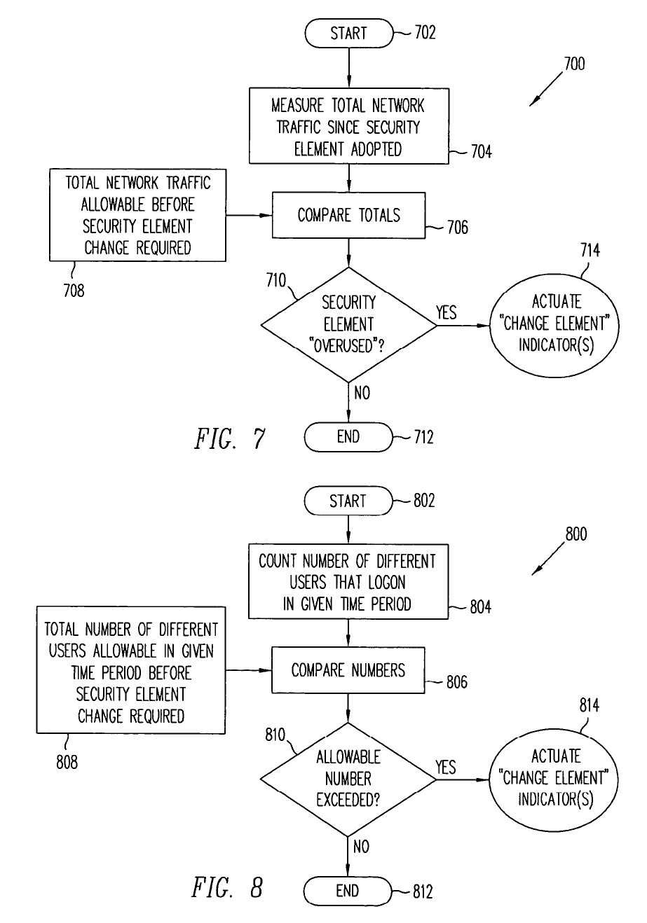

Another method 700 for indicating the need to change an encryption element, based on the total volume of traffic transported over the network 100 using the element, is illustrated in FIG. 7. After initiation of the method at step 702, which may be manual or automatic, the cumulative amount of traffic that has been transported over the network using the current encryption element, which has been continuously monitored by the controller 418 and stored in the memory subsystem 420 of the AP 402 at step 704, is compared at step 706 to a selected total amount of network traffic allowable before a element change is recommended, i.e., 100 MB, which value can be either fixed or selected by the user and stored in the AP memory subsystem at the time the security features of the AP are configured at step 708.

The allowable and actual network traffic totals are mathematically compared, and a determination is made at step 710 whether the total amount of traffic that has been transported over the network using the current element exceeds the total amount of traffic allowable. If the encryption element is still fresh, i.e., the allowable amount of traffic using the element has not been exceeded, the routine terminates at step 712, but if a determination is made that the key has been “overused,” the controller actuates the security status indicator 404 at step 714 to indicate to the user, i.e., by changing the color of an LED from green to amber or red, or by flashing it on an off, or by sounding an audible tone, that the encryption key needs to be changed.

Another example method 800 for indicating the need to change an encryption element of the network, based on the total number of unique or different users that have logged onto the network 100 using the element during a given period of time, is illustrated in the flow chart of FIG. 8. After initiation of the routine at step 802, which as above, may be effected manually or automatically, and periodically or continuously, the cumulative number of different users that have logged onto the network using the current encryption element from a given initial point in time, which has been continuously monitored by the controller and stored in the memory subsystem 420 of the AP 402 at step 804, is compared at step 806 to a selected total number of different users that are allowed to log onto the network using the encryption element during the selected period of time before an element change is indicated, i.e., 100 different users logging on to the network during, i.e., the period of a week, which number/time period values can be either fixed or selected by the user and stored in the AP memory subsystem 420 at the time the security features of the AP 402 is configured at step 808.

The total number of different users of the network are mathematically compared to the total number allowable, and a determination is made at step 810 whether the total users exceeds the total allowable. If the allowable number has not been exceeded, the routine terminates at step 812, and if the number has been “exceeded,” the controller actuates the status indicator 404 at step 814 to indicate to the user, i.e., by changing the color of an LED from green to amber or red, or by flashing it on an off, or by sounding an audible warning tone, that the encryption element needs to be changed.

By now, those of skill in this art will appreciate that many modifications, substitutions and variations can be made in and to the apparatus, configurations and methods of the network security status indicator of the present invention without departing from its spirit and scope. For example, instead of or in addition to the visual and/or audible indicators described above, it is possible for the controller 418 to generate network security status text messages, including security level change warnings, which can be displayed on a user's computer display with a “popup” or network security “wizard” or other utility used to manage the network security through the AP 402. In another particular possible embodiment, the controller 418 of the AP can be programmed to send the user an electronic text or pictorial notification, such as an e-mail message or other type of text message, advising the user of the current network security status and any changes that have recently occurred thereto.

In light of the many foregoing possible variations, the scope of the present invention should not be limited to that of the particular embodiments illustrated and described herein, as they are only example in nature, but instead, should be fully commensurate with that of the claims appended hereafter and their functional equivalents.

What is claimed is:

1. An apparatus, comprising:
a sensor for sensing one or more operational parameters of a network associated with the current security state of the network;
a comparator for comparing the parameters sensed with a plurality of groups of corresponding parameters, each group being uniquely associated with a corresponding one of a number of possible security states of the network, and for determining the actual current operational security status of the network based on the comparison;
a signal generator for generating a signal corresponding to the security status determined; and,
an applicator for applying the signal to an indicating device such that the device produces an indication corresponding to the actual current security status of the network that is visible, audible or both visible and audible to a user of the network.

2. The apparatus of claim 1, wherein the network is a heterogeneous or a homogeneous network.

3. A network device incorporating the apparatus of claim 1.

4. The apparatus of claim 1, wherein the indicating device comprises an electric light source, an electro-acoustic transducer, or both an electric light source and an electro-acoustic transducer.

5. The apparatus of claim 1, wherein:
the indicating device comprises an LED capable of producing light of a selected one of a plurality of colors;
the security status of the network comprises one of plurality of possible security states; and,
the LED produces light of a selected color corresponding to a respective one of each of the possible security states.

6. The apparatus of claim 1, wherein:
the indicating device comprises a plurality of LEDs, each capable of being lit selectively and independently of the others;
the security status of the network comprises one of plurality of possible security states; and,
the LEDs are lit in selected combinations corresponding to respective ones of each of the possible security states of the network.

7. The apparatus of claim 1, wherein the security status of the network is at least in part a function of a pre-shared security element, and further comprising:
an apparatus for measuring the length of time that the element has been in use on the network;
an apparatus for generating a signal when the length of time that the element has been in use exceeds a selected value; and,
an apparatus for applying the signal to an indicating device such that the device produces an indication corresponding to a need to change the element that is visible, audible or both visible and audible to a user of the network.

8. The apparatus of claim 1, wherein the security status of the network is at least in part a function of a pre-shared security element, and further comprising:
an apparatus for measuring the amount of traffic that has been transported over the network using the element;
an apparatus for generating a signal when the amount of traffic that has been transported over the network using the element exceeds a selected value; and,
an apparatus for applying the signal to an indicating device such that the device produces an indication corresponding to a need to change the element that is visible, audible or both visible and audible to a user of the network.

9. The apparatus of claim 1, wherein the security status of the network is at least in part a function of a pre-shared security element, and further comprising:
an apparatus for counting the number of different users that have logged onto the network in a given period of time using the element;
an apparatus for generating a signal when the number of different users that have logged onto the network in the given period of time using the element exceeds a selected value; and,
an apparatus for applying the signal to an indicating device such that the device produces an indication corresponding to a need to change the element that is visible, audible or both visible and audible to a user of the network.

10. The apparatus of claim 7, wherein the indicating device comprises an electric light source, an electro-acoustic transducer, or both an electric light source and an electro-acoustic transducer.

11. The apparatus of claim 8, wherein the indicating device comprises an electric light source, an electro-acoustic transducer, or both an electric light source and an electro-acoustic transducer.

12. The apparatus of claim 9, wherein the indicating device comprises an electric light source, an electro-acoustic transducer, or both an electric light source and an electro-acoustic transducer.

13. A method, comprising:
sensing one or more operational parameters of the network associated with the current security state of the network;
comparing the parameters sensed with a plurality of groups of corresponding parameters, each group being uniquely associated with a corresponding one of a number of possible security states of the network, and determining the actual current operational security status of the network based on the comparison;
generating a signal corresponding to the security status determined; and,
applying the signal to an indicating device such that the device produces an indication corresponding to the actual current security status of the network that is visible, audible or both visible and audible to a user of the network.

14. The method of claim 13, wherein the network is a heterogeneous or a homogeneous network.

15. A network device operative to indicate the security status of the network to a user thereof in accordance with the method of claim 13.

16. The method of claim 13, wherein the indicating device comprises an electric light source, an electro-acoustic transducer, or both an electric light source and an electro-acoustic transducer.

17. The method of claim 13, wherein:
the indicating device comprises an LED capable of producing light of a selected one of a plurality of colors;
the security status of the network comprises one of plurality of possible security states; and,
applying the signal to the indicating device comprises causing the LED to produce light of a selected color corresponding to a respective one of each of the possible security states.

18. The method of claim 13, wherein:
the indicating device comprises a plurality of LEDs, each capable of being lit selectively and independently of the others;
the security status of the network comprises one of plurality of possible security states; and,
applying the signal to the indicating device comprises causing the LEDs to light in selected combinations corresponding to respective ones of each of the possible security states.

19. The method of claim 13, wherein the security status of the network is at least in part a function of a pre-shared security element, and further comprising:
measuring the length of time that the element has been in use on the network;
generating a signal when the length of time that the element has been in use exceeds a selected value; and,
applying the signal to the indicating device such that the device produces an indication corresponding to a need to change the element that is visible, audible or both visible and audible to a user of the network.

20. The method of claim 13, wherein the security of the network is a function at least in part of a pre-shared security element, and further comprising:
detecting the amount of traffic that has been transported over the network using the element;
generating a signal when the amount of traffic that has been transported over the network using the element exceeds a selected value; and,
applying the signal to the indicating device such that the device produces an indication corresponding to a need to change the element that is visible, audible or both visible and audible to a user of the network.

21. The method of claim 13, wherein the security of the network is at least in part a function of a pre-shared security element, and further comprising:
counting the number of different users that have logged onto the network in a given period of time using the element;
generating a signal when the number of different users that have logged onto the network in a given period of time using the element exceeds a selected value; and,
applying the signal to the indicating device such that the device produces an indication corresponding to a need to change the element that is visible, audible or both visible and audible to a user of the network.

22. The method of claim 19, wherein:
the indicating device comprises an LED; and,
applying the signal to the indicating device comprises causing the LED to blink on and off.

23. The method of claim 20, wherein:
the indicating device comprises an LED; and,
applying the signal to the indicating device comprises causing the LED to blink on and off.

24. The method of claim 21, wherein:
the indicating device comprises an LED; and,
applying the signal to the indicating device comprises causing the LED to blink on and off.
